(19) United States
(12) Patent Application Publication
(10) Pub. No.: US 2008/0247615 A1
(43) Pub. Date: Oct. 9, 2008

(54) Two-Way Scanning Fingerprint Sensor

(76) Inventor: Jean-Françios Mainguet, Grenoble (FR)

Correspondence Address: FISH & RICHARDSON P.C., PO BOX 1022, MINNEAPOLIS, MN, 55440-1022, US

(21) Appl. No.: 10/575,272

(22) PCT Filed: Nov. 8, 2004
(86) PCT No.: PCT/EP2004/052870

§ 371 Date: Apr. 11, 2006

(30) Foreign Application Priority Data
Nov. 21, 2003 (FR) 0313661

(51) Int. Cl. G06K 9/00

(52) U.S. Cl. 382/125

(57) ABSTRACT

The invention relates to the recognition of fingerprints, and more particularly to the recognition on the basis of an elongate strip-shaped sensor of detectors capable of detecting the ridges and valleys of fingerprints during the relative scrolling of a finger with respect to the sensor substantially perpendicularly to the direction of elongation of the strip. To improve the security of recognition, provision is made for a scrolling of the finger in two opposite directions and for a verification that the image deformation between the two directions corresponds to a normal deformation having regard to the natural plasticity of the skin.

### FIELD OF THE INVENTION

The invention relates to the recognition of fingerprints, and more particularly to the recognition on the basis of an elongate strip-shaped sensor of detectors which are capable of detecting the ridges and valleys of fingerprints during the relative scrolling of a finger with respect to the sensor substantially perpendicularly to the direction of elongation of the strip.

### BACKGROUND OF THE INVENTION

Such sensors of elongate shape, that are smaller than the image of the finger to be gathered and which cannot therefore gather this image other than by virtue of relative scrolling between the finger and the sensor, have already been described. These sensors can operate mainly by optical or capacitive or thermal or piezoelectric detection.

These sensors have the advantage, as compared with non-scrolling sensors on which the finger is left stationary, of being cheap on account of the small surface area of silicon that they use. However, they require a reconstruction of the global image of the finger since this image is acquired only line by line or a few lines at a time.

In the French patent published under number FR 2 749 955 is described a principle of detection by an elongate sensor comprising several lines for successively acquiring partial images of the print, these images mutually overlapping, so that by searching for a correlation between two successive images, it is possible to superimpose these successive images shifted in tandem with the scrolling of the finger and to progressively reconstruct the global image of the print without needing to ascertain through additional means the speed of scrolling of the finger with respect to the sensor.

In applications where fingerprint image recognition serves to ensure the security of an application, for example, to authorize physical or electronic access exclusively to authorized persons, the image thus reconstructed is used to compare it with prerecorded images.

Therein lies a possibility of falsification if a fraudster uses an artificial finger whose surface is molded or etched with a relief which imitates the relief of an authorized person's fingerprint.

An aim of the invention is to limit the risks of fraud of this type.

### SUMMARY OF THE INVENTION

To achieve same, the invention proposes a method of detection which provides for a double operation of swiping of the finger over the surface of the scrolling sensor, a swipe being performed in one direction and the other in the opposite direction, an image reconstruction for each of the two directions of scan, and a verification that the difference between the images gathered in the course of the two swipe directions corresponds to a normal image deformation due to the natural plasticity of the skin of a live finger.

Consequently, the invention relies on the observation that in the case of image captures by scrolling of the finger over a linear sensor, the image of the finger scrolling in one direction is not identical to the image of the finger scrolling in the other direction, the rubbing of the finger on the sensor inducing in fact, on account of the plasticity of the skin, a stretching or a bunching of the ridge lines of the print according to the direction of scrolling and according to the position of the print zone considered.

This stretching or this bunching are not apparent if a false finger, made from a low-plasticity material, is swiped over the surface of the sensor. Security will therefore be improved because a false finger will not in general exhibit plasticity characteristics sufficiently close to those of the skin.

This operation of verification of the difference between the two images is compounded with the operation of print recognition proper and offers an additional degree of security as compared with straightforward print recognition that is customarily done.

### BRIEF DESCRIPTION OF DRAWINGS

Other characteristics and advantages of the invention will become apparent upon reading the detailed description which follows and which is given with reference to the appended drawings in which:

FIGS. 1a and 1b represent a fingerprint registered in two oppositely-directed scanning movements;

FIGS. 2a, 2b and 2c symbolize the nature of the print deformations noted;

FIGS. 3a and 3b represent a way of measuring the distortions of the print;

FIGS. 4a and 4b represent the variations in signal corresponding to a pixel placed at the center of the finger and seeing this finger scroll in one direction or in the opposite direction.

### DETAILED DESCRIPTION OF EMBODIMENTS

Experience has shown that, in essence, the nature of the deformation due to the plasticity of the skin is of the following form: the ridge lines tend to pack together (compression of the image in the direction of displacement) for the part of the finger that is situated toward the front in the direction of displacement, whereas the ridge lines tend to thin out (extension of the image in the direction of displacement) for the part of the finger that is situated rather more to the rear in the direction of displacement.

This double deformation, dependent on the finger zone considered, results from the pressure applied by the finger against the surface of the sensor, which pressure is greater in the part situated at the front in the direction of displacement and is weaker in the part situated at the rear.

The compressional or extensional deformation is stronger toward a center line of the finger (line parallel to the direction of displacement) than on the sides straddling this center line. The reason therefor is here again the fact that the pressure is greater on the central line and decreases on either side of this line, until it becomes zero on the edges, just where the finger ceases progressively, on account of its shape, to be in contact with the sensor.

It is interesting to note that the overall height of the image detected does not vary much in the direction of displacement, the compression of the front zone of the finger compensating more or less for the stretching of the rear zone; toward the center of the finger (between the front and the rear), the deformation may be considered to be nonexistent.

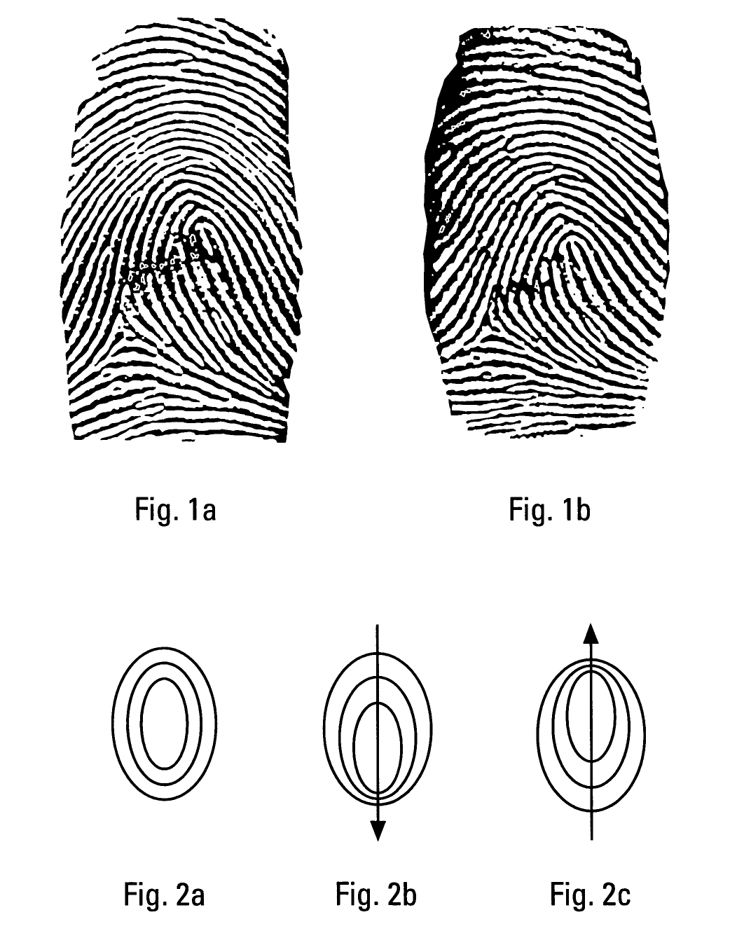

FIG. 1a represents an exemplary fingerprint detected and reconstructed during an upwards displacement, FIG. 1b representing the image detected and reconstructed during a displacement of the finger downwards. The ridge lines of the prints are more bunched in the top part of the image of FIG. 1a than in the corresponding top part of the image of FIG. 1b; conversely they are more spaced out in the bottom part of the image of FIG. 1a than in the bottom part of the image of FIG. 1b. Toward the center of the image, the difference is not noticeable.

It may be imagined that a theoretical finger image (observed statically) would be an intermediate image between the two images.

An image captured in the two directions of displacement with the aid of a false finger molded from rigid material would not give different prints for the two directions of displacement.

FIG. 2 (2a, 2b, 2c) schematizes the principle of the distortion observable for a live finger, in the form of a symbol in which the print lines are assumed, in a static state, to be equidistant oval contours (FIG. 2a); in the course of a displacement, the lines are more bunched toward the front of the direction of displacement; they are more stretched toward the rear; they are displaced little on the sides; in the downward displacement (FIG. 2b) it is therefore the bottom lines of the image which are more bunched and the top lines of the image which are more spaced out; during an upward displacement (FIG. 2c) the converse is the case. This observation is used to strengthen security against fraud with the aid of a false finger.

When performing image recognition and comparison with a prerecorded image of an authorized person's print (or with a library of images of authorized prints), one will not be content with a straightforward comparison but one will supplement the authorization test with a verification that the images obtained in the opposite directions of displacement exhibit minimal distortions compatible with the natural plasticity of the skin.

Prints taken in both directions of scrolling for each authorized person could be recorded in the library of authorized images; the image taken in the first direction would then be compared with the prerecorded images taken likewise in the first direction. And the comparison would also be made for the image recorded in the opposite direction of scrolling. An authentication would be accepted only if a coincidence is detected for two prerecorded images and if these two images correspond to the two directions of scrolling for the same person. However, in practice, this requires the prerecorded image to have also been captured and recorded on the basis of the same scrolling sensor, or in any event on the basis of a scrolling sensor.

It is also possible to carry out a single recognition of an image by comparing a reconstructed image with a single prerecorded image, captured either statically or with scrolling in a single direction. In this case, the authentication will be supplemented with an evaluation of the image distortion due to the scrolling and a verification that this distortion is normal and corresponds a priori to a live finger.

In essence, this verification consists in determining a percentage of distortion of the image and in making sure that this percentage is situated between two limits. The limits are
a lower limit, since if the distortion is too weak, this is perhaps because a molded or etched false finger is used in place of a live finger,
and an upper limit, since an exaggerated distortion between the two directions of scrolling would prevent correct identification of the mean image of the finger hence of the person to be authenticated.

To detect the distortion, it is possible to use notable points of the print that are called “minutiae”. The notable points or minutiae are the points at which a ridge line stops or the points at which a ridge line divides and separates into two ridge lines.

One procedure consists in tagging three notable points along the axis or close to the axis of scrolling, these notable points being visible on the images captured in the two directions of scrolling.

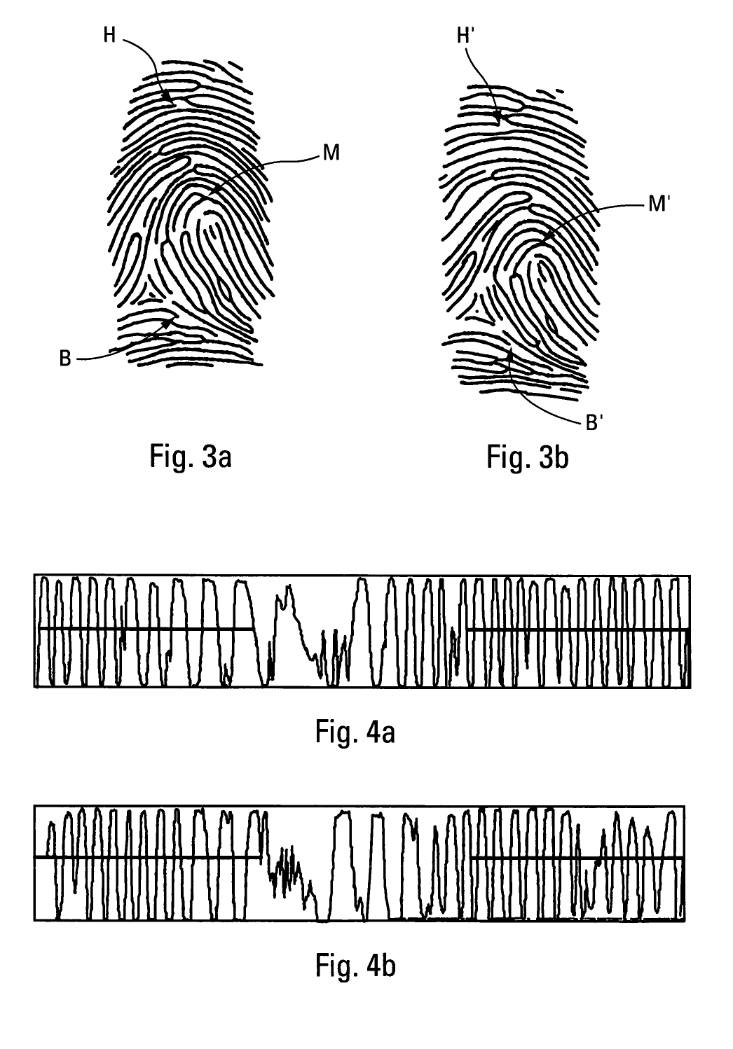

FIG. 3a and FIG. 3b represent an image in one direction and an image in the other direction, and indicated in FIG. 3a are three notable points H, B and M, situated respectively toward the front of the finger, toward the rear of the finger and toward the middle of the finger. These same notable points are denoted H′, B′ and M′ in FIG. 3b.

The distances HM and MB, HM′ and MB′ are measured for the two acquisitions.

Having regard to the natural distortion, the distance HM will usually be smaller than H′M′ and the distance MB will usually be larger than M′B′.

This distance can be calculated as a number of vertical pixels (the vertical representing the direction of scrolling).

The ratio H′M′/HM is typically of the order of 0.85, whereas the ratio M′B′/MB is typically equal to the inverse, i.e. 1/0.85. There is therefore a distortion of the order of 15% which corresponds to the natural plasticity of the skin.

A typical range of values of distortion is from 10% to 25%, that is to say the image will be considered to be acceptable if the degree of distortion between the two directions of scrolling, for the top or bottom regions of the print, lies between 10% and 25% and unacceptable if it departs from this range. The recognition of the print will be accepted by the system on condition that the distortion is greater than a first threshold and preferably also on condition that it is less than a second threshold.

The positions of the notable points may be tagged on the basis of contour extraction software.

Rather than taking notable points as direct tags on the basis of which distances between these points are measured, it is possible to take the notable points as indirect tags and to find tag points H″, B″ and M″ on the basis of these indirect tags: for example the tag points H″, B″ and M″ are points all situated on one and the same vertical, and it is the distances on this vertical which are measured and which serve for calculating the distortions.

Rather than using fairly complex image recognition software to find positions of notable points, it is possible to use other means to measure the distortion in the top part and the bottom part of the image. In particular, it is possible to evaluate the mean spacing of the print lines in the top part and the mean spacing in the bottom part.

It is possible to separate the image to be analyzed into two or three equal parts. The spatial frequency of the ridges of the print are measured in the vertical direction for the upper part and the lower part.

FIG. 4a represents the signal provided by a pixel situated at the center of the detection strip and which sees the ridges of the print scroll past. The generally sinusoidal form of the signal reflects the successive passage of ridges and of troughs of the print. It is possible to simply count the number of alternations of the signal over a given image length, on the one hand in the top part and on the other hand in the bottom part of the image. FIG. 4b represents the signal obtained during scrolling in the opposite direction. The numbers of alternations are again counted for the corresponding parts of the image, over identical image lengths.

The ratio of the numbers of alternations of the corresponding regions for the two directions of scrolling is a measure of the distortion of the print.

This counting of alternations is, however, somewhat inaccurate and it is preferable to determine a mean spatial frequency through a Fourier transform calculation of the image of the top region and of the bottom region of the finger. The transform may be calculated on the entire image or on a vertical band at the center of the finger over the entire length of the top part on the one hand, over the entire length of the bottom part on the other hand.

The Fourier transform reveals a low-frequency component characteristic of the periodicity of scrolling of the prints in the top region and a characteristic frequency in the bottom region. The ratio of the values of this characteristic frequency for a given region and for the two directions of scrolling is a measure of the difference in distortions. Typically, a ratio of less than 10% will be considered to be unacceptable because it is unlikely to correspond to a live finger, and a ratio of greater than 25% will also be considered to be unacceptable, such a deformation not allowing sufficiently reliable determination of a mean static print reconstruction on the basis of which a comparison with prerecorded prints may be performed.

If a measurement is made both on the bottom part and the top part of the image, the distortion can be considered to be satisfactory either if the two parts of the image satisfy the acceptable distortion criterion or if at least one of the two parts of the image satisfies this criterion.

The invention is applicable in respect of print sensors of all kinds: based on optical, or capacitive, or thermal or piezoelectric detection in particular, but it is especially of interest in the case of a sensor in any event requiring firm physical contact between the sensor and the finger (capacitive, thermal or piezoelectric sensors).

The successive scanning in the two directions may be performed without raising the finger between the two passes.

1-8. (canceled)

9. A method of fingerprint detection by means of an elongate strip-shaped scrolling sensor, comprising the steps of:
a double operation of swiping of the finger over the surface of the scrolling sensor, a swipe being performed in one direction and the other in the opposite direction;
reconstructing an image for each of the two directions of scan, and
verification that the difference between the images gathered in the course of the two swipe directions corresponds to a normal image deformation due to the natural plasticity of the skin of a live finger.

10. The method of detection as claimed in claim 9, wherein the verification comprises a measurement of deformation in a top part and in a bottom part of the image, a comparison with a threshold, and an acceptance on condition that the deformation is greater than a threshold for at least one of the two parts.

11. The method of detection as claimed in claim 10, wherein acceptance is provided on condition that the deformation is greater than a threshold for the two parts.

12. The method of detection as claimed in claim 10, wherein the acceptance is provided on condition that the deformation is less than another threshold.

13. The method of detection as claimed in claim 9, wherein the verification comprises a measurement of position of notable points common to the two reconstructed images, a calculation of distances between notable points for each of the two images, a calculation of the ratio of the distances, and a comparison of the ratio with at least one threshold.

14. The method of detection as claimed in claim 9, wherein the verification comprises a measurement of spatial frequency of the ridges of prints in at least one part of the image of the finger, for the two directions of scan, a calculation of the ratio of the spatial frequencies found for the two images, and a comparison of the ratio with at least one threshold.

15. The method as claimed in claim 14, wherein the spatial frequency is determined by Fourier transform on a part of the image of the finger.

16. The method as claimed in claim 14, wherein the spatial frequency is determined by counting alternations of the signal detected in a determined image part.

17. The method of detection as claimed in claim 11, wherein the acceptance is provided on condition that the deformation is less than another threshold.

18. The method of detection as claimed in claim 10, wherein the verification comprises a measurement of position of notable points common to the two reconstructed images, a calculation of distances between notable points for each of the two images, a calculation of the ratio of the distances, and a comparison of the ratio with at least one threshold.

19. The method of detection as claimed in claim 11, wherein the verification comprises a measurement of position of notable points common to the two reconstructed images, a calculation of distances between notable points for each of the two images, a calculation of the ratio of the distances, and a comparison of the ratio with at least one threshold.

20. The method of detection as claimed in claim 12, wherein the verification comprises a measurement of position of notable points common to the two reconstructed images, a calculation of distances between notable points for each of the two images, a calculation of the ratio of the distances, and a comparison of the ratio with at least one threshold.

21. The method of detection as claimed in claim 10, wherein the verification comprises a measurement of spatial frequency of the ridges of prints in at least one part of the image of the finger, for the two directions of scan, a calculation of the ratio of the spatial frequencies found for the two images, and a comparison of the ratio with at least one threshold.

22. The method of detection as claimed in claim 11, wherein the verification comprises a measurement of spatial frequency of the ridges of prints in at least one part of the image of the finger, for the two directions of scan, a calculation of the ratio of the spatial frequencies found for the two images, and a comparison of the ratio with at least one threshold.

23. The method of detection as claimed in claim 20, wherein the verification comprises a measurement of spatial frequency of the ridges of prints in at least one part of the image of the finger, for the two directions of scan, a calculation of the ratio of the spatial frequencies found for the two images, and a comparison of the ratio with at least one threshold.

24. The method as claimed in claim 21, wherein the spatial frequency is determined by Fourier transform on a part of the image of the finger.

25. The method as claimed in claim 21, wherein the spatial frequency is determined by counting alternations of the signal detected in a determined image part.

26. The method as claimed in claim 22, wherein the spatial frequency is determined by Fourier transform on a part of the image of the finger.

27. The method as claimed in claim 22, wherein the spatial frequency is determined by counting alternations of the signal detected in a determined image part.
